(19) United States
(12) Patent Application Publication
(10) Pub. No.: US 2002/0052235 A1
(43) Pub. Date: May 2, 2002

(54) Gaming device having animation including multiple sprites

(76) Inventors: Jeffrey R. Hirsch, Reno, NV (US); Johnny L. Palchetti, Reno, NV (US)

Correspondence Address: BELL, BOYD & LLOYD LLC, P. O. BOX 1135, CHICAGO, IL, 60690-1135, US

(21) Appl. No.: 09/819,392

(22) Filed: Mar. 28, 2001

Related U.S. Application Data
(63) Continuation-in-part of application No. 09/698,310, filed on Oct. 27, 2000.

(51) Int. Cl. G06F 17/00

(52) U.S. Cl. 463/31

(57) ABSTRACT

The present invention involves a gaming device which can display a plurality of graphical images at any one time. One or more of these graphical images are specified with predetermined sizes relative to a display frame preferably in addition to predetermined Z-levels, movements and other specifications. This type of gaming device provides players with more realistic and enhanced graphics, adding to a player's excitement and entertainment.

### PRIORITY CLAIM

This application is a continuation-in-part application of U.S. patent application, Ser. No. 09/698,310, filed on Oct. 12, 2000, entitled “Gaming Device Having Animation Including Multiple Sprites.”

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### DESCRIPTION

The present invention relates in general to a gaming device, and more particularly to a gaming device with animation involving a plurality of sprites displayed at any one time.

### BACKGROUND OF THE INVENTION

Contemporary gaming machines, such as slot machines, include a primary game and one or more bonus rounds. Typically, a bonus round begins when the player reaches a bonus triggering event in the primary game. In slot machines with reel-based primary games, the triggering event usually occurs when the player reaches a predetermined combination of symbols on the reels. Usually the bonus scheme provides the player with an opportunity to gain a bonus value before the bonus round terminates.

Most of these gaming machines use computer-generated games in the bonus rounds. Increasingly, gaming machines use computer-generated games in primary games as well. The term computer game, as used herein, includes a game played by a player or any activity viewed by a player which is implemented or generated by a computer and which displays computer graphics on a monitor or screen or other similar display device.

Today, the fundamental role of graphics in almost all computer games is animation. Animation is the illusion of movement. In the case of television, the illusion of movement is created by displaying a rapid succession of images with slight changes in content. The human eye perceives these changes as movement because of the relatively low visual acuity of the eye. The human eye can be tricked into perceiving animation when an image or frame is moved as low as twelve times per second. This rate, commonly known as the frame rate, is measured in terms of frames per second (fps). Twelve frames per second is the minimum target speed for most computer games. Though twelve fps is sufficient to create the illusion, the animation at this frame rate appears somewhat rough or jerky. Therefore, most professional animations use higher frame rates. For instance, the frame rate for television is thirty fps, and the frame rate for motion pictures is approximately twenty-four fps.

Unlike television and motion pictures, computer games are much more limited in their capacity to handle frame rate. Frame rates in computer games require a relatively high amount of computer processing and memory. Consequently, game developers must balance the amount of frame rate against the computer system speed and resources. By using a relatively low resolution and relatively simple graphics, a game can have an increased frame rate and generate relatively smooth animations. Of course, the draw-back is the relatively low resolution and simple graphics. Although there are many types of animation used in computer games, the two basic types are commonly known as “Frame-Based Animation” and “Cast-Based Animation” which are discussed below.

Frame-based Animation

A relatively simple animation technique is frame-based animation. It involves simulating movement by displaying a sequence of pregenerated, static frame images. A movie is a perfect example of frame-based animation. The film consists of many slightly different frames, and when the frames are shown in rapid succession, they create the illusion of movement. Frame-based animation has no concept of a graphical image distinguishable from a background graphical image. Instead, everything appearing in a frame is part of that frame as a whole. The result is that each frame image contains all the information necessary for that frame in a static form.

Frame-based animation has several disadvantages in computer games. The traditional computer system 10 used for frame-based animation is schematically shown in FIG. 1. This computer system 10 includes: a central processing unit (CPU) 12; a memory device 14 for storing program code or other data; a frame buffer random access memory device 16 (referred to herein as “frame buffer 16”); a display processor 18; a display device 20; a display frame 22; and various input and output devices. Such input and output devices include a coin or bill acceptor 24, any other input devices 26, a sound card 28 and one or more speakers 30. All of these components communicate with each other through a control and communications bus 32. The memory device 14 can include a random access memory (RAM) 34 for storing event data or other data generated or used during a particular game and a read only memory (ROM) 36 for storing animation program code or other program code.

The display device 20 is either constructed of cathode ray tubes (CRT) or flat-panel displays. This type of display device 20 utilizes raster graphics in which an image is specified in terms of an array of component points called pixels (short for “picture elements”). With raster graphics, display frame 22 is formed from a set of horizontal scan lines, each made up of individual pixels (not shown). Consequently, the display frame 22 is a matrix of pixels covering the entire screen area of display device 20. A game developer specifies a display frame 22 with a matrix of pixel values which correspond to the pixel matrix. These values specify color and brightness.

In the operation of frame-based animation, CPU 12 uses a computer program stored in memory device 14 to write specific pixel values to correct locations in the frame buffer 16. Display processor 18 reads these values and converts them to the appropriate signals for driving display device 20. Display device 20 then generates colors and brightness levels on display frame 22. The result is a frame image, often referred to as a bit-mapped image.

Essential to frame-based animation is the fact that the CPU 12 creates the pixel data for everything that appears on display frame 22 and stores the resulting image in the frame buffer 16. Then for the next frame, CPU 12 must erase (or write over) the entire frame buffer 16 memory and recreate all of the pixel data for the entire image, even though the image does not change or only changes slightly. In other words, the frame buffer 16 memory must be cleared between frames. Since frame-based animation requires many frames to be displayed in rapid succession, this task can be a great burden on computer systems.

Furthermore, the CPU updates every graphical image in a display frame at the same rate regardless of its actual motion in a scene or its importance in a game scenario. As such, valuable time and computer processing and memory resources are spent recreating graphical images, such as background images, which do not change significantly from frame to frame.

Another drawback is that all of the graphical images in a display frame must be created with the same resolution. In effect, the amount of computer processing and memory resources consumed in frame-based animation depends upon the size of the graphical image rather than the importance of the graphical image in the game scenario. For example, most computer games involve active characters against a background image that rarely changes. Recreating the background image from frame to frame is far more costly than recreating the active characters, because the background image is greater in size. The background image thus continually demands relatively high computer processing and memory resources even though it has relatively little importance in the game scenario. One way to get around these difficulties is to use cast-based animation in computer games.

### Cast-based Animation

Many computer games currently employ cast-based animation, a more powerful animation technique than frame-based animation. Cast-based animation, also known as “sprite animation,” involves graphical images that move independently of one another. The term, graphical image, as used herein, includes any image or portion of an image which appears on part or all of an overall computer screen or display frame. For example, in the animation of a spaceship game, the spaceships are separate graphical images that appear on part of a starfield background image. Furthermore, if the stars moved with respect to a black background image, each star would be a separate graphical image. A graphical image is commonly referred to as a “sprite.”

Unlike frame-based animation which requires a computer system to generate numerous frames, a computer system only needs to generate one frame in cast-based animation. Furthermore, the game developer can allocate valuable computer system resources among the various sprites by determining which sprites will move and which ones will not move. Cast-based animation is commonly used in game scenarios which involve sprites which are moving from one location to another, sometimes referred to as scaling.

In certain scenarios, the computer games used in gaming machines currently do not include cast-based animation, but rather use the traditional frame-based animation. For example, when a developer wants a background image to change in order to cause a foreground image to have apparent movement, it is common to use a sequence of background frame images. Consequently such gaming machines have all of the disadvantages associated with frame-based animation discussed above.

To increase player enjoyment and excitement, it is desirable to provide players with new gaming machines which provide more realistic and interactive animations.

### SUMMARY OF THE INVENTION

The present invention overcomes the above shortcomings by providing a gaming device with a computer system which generates independent graphical images or sprites on a display frame of a display device. In one embodiment, the computer system includes a CPU, a memory device, a sprite random access memory device, a display processor, a display device, a display frame, one or more input and output devices and a bus enabling these components to communicate. The sprite random access memory device includes a plurality of sprite buffer random access memory devices (referred to herein as “sprite buffers”).

The computer system of the present invention can be stored and operated locally at each gaming device, or the computer system can remotely operate one or more gaming devices. Such remote operation can involve one or more networks wherein one or more central computers or processors each operate a plurality of gaming devices. It should be appreciated that the present invention can include other communication configurations which enable a gaming device to be operated by a processor not residing at the gaming device.

This embodiment includes a sprite computer program stored in the memory device and used by the CPU to write pixel data. The specifications for the sprites in the program can vary from computer game to computer game. Such programs can be written in Java, C++ or any other type of computer code. The sprite program enables a sprite to have a plurality of specifications, including, but not limited to specified horizontal and vertical display frame coordinates relative to the display frame, as well as a specified depth coordinate or Z-level, relative to other sprites. These specifications allow the computer system to layer the various sprites on the display frame.

Other sprite specifications include: a size or dimension for a sprite which can be smaller or larger than the size or a dimension of the display frame; a velocity for a sprite; a boundary for a sprite; a predetermined number of frames; and a current frame. In addition, based upon a predetermined computer program, the computer system can include pixels which are defined as unused or transparent. When transparent pixels are included in sprites, the background of the sprite appears in place of the transparent pixels.

In operation, the CPU uses the sprite program to write specified pixel values to various sprite buffers. Each sprite buffer includes certain specifications for a single sprite. The display processor reads each sprite buffer, individually, and performs the necessary manipulations to drive the display device in such a manner that various sprites are generated and displayed, exhibiting their individual specifications.

An alternative embodiment of the present invention can use the convention computer system configured for frame-based animation, as schematically shown in FIG. 1 and described earlier. In this embodiment, the CPU uses an animation program stored in the memory device to write separate pixel data for individual sprites. Preferably, the CPU writes the pixel data to the frame buffer for each sprite, one by one. Here, it is necessary to write the pixel data for the sprites in the order from back (most screen depth) to front (least screen depth). In this manner, the front-most sprites overwrite previously written sprites. The result is that the sprites appear layered in accordance with their specified depths. It should be appreciated, however, that the CPU can instead combine the separate pixel values and, using appropriate logic, write the combined data to the frame buffer, thereby causing the layered appearance.

It should be appreciated that the computer system of the present invention can incorporate frame-based animation techniques into sprite animation. Specifically, a sprite can be displayed in a plurality of frames. This embodiment can be used when a sprite exhibits movement other than scalar movement, such as a character's gestures.

Furthermore, the computer system of the present invention can be adapted to detect collision between two or more sprites. Such collision detection can be accomplished by the CPU comparing the positions of the sprites relative to one another. Once a detection occurs, the computer system can perform any event predetermined by a program stored in the memory device.

In one preferred embodiment, particular size or dimension and velocity specifications are used for a background sprite. In order to cause foreground sprites to have apparent scalar movement (change in the XY position), a background sprite is specified with a predetermined velocity or movement and a size or dimension which is greater than that of the display frame. Specifically, the height and/or width of the background sprite is greater than the height and/or width of the display frame. The CPU writes pixel values, according to these specifications, for the entire background sprite. As an illustration, the background sprite can be thought of as scenery on a sheet of paper which is several times wider than the display frame. The sheet of paper can be thought of as pulled through the display frame in a scrolling fashion, for instance, from left to right. A foreground sprite, such as a person, will thus appear to be walking from right to left.

The display device can display sprites which are larger than the display frame in any suitable fashion. In one embodiment, the sprite is divided into a plurality of compartments or sections, where each section includes a set of pixel values. The CPU writes transparent pixel values for all but one of the sections. The display device displays all of the sections at once, but only one is visible. As time elapses, the CPU changes the pixel values for certain sections from transparent to non-transparent and vice versa.

The present invention includes a gaming device which enables a computer system to display independent, moving graphical images or sprites in a single frame at one time. The computer system uses sprite buffers which store the pixel data as specified for each sprite in a computer program. This type of gaming device can be used to display a plurality of independent graphical images (including, but not limited to, object sprites, character sprites and background sprites) which move with respect to one another and which can be specified with various sizes or dimensions (including, but not limited to, sizes or dimensions greater than the size or dimensions of the display frame). Furthermore, the computer system of the present invention enables gaming devices to conserve and allocate processing and memory resources among the various sprites, thereby providing players with more realistic and interactive gaming device graphics.

It is therefore an object of the present invention to provide a gaming device which has animation, including multiple sprites.

Other objects, features and advantages of the invention will be apparent from the following detailed disclosure, taken in conjunction with the accompanying sheets of drawings, wherein like numerals refer to like parts, elements, components, steps and processes.

### BRIEF DESCRIPTION OF THE DRAWINGS

FIG. 1 is a schematic block diagram of a prior art, traditional computer system for a gaming device;

FIG. 2A is a perspective view of one embodiment of the gaming device structure of the present invention;

FIG. 2B is a perspective view of another embodiment of the gaming device structure of the present invention;

FIG. 3 is a schematic block diagram of the computer system of one embodiment of the gaming device of the present invention;

FIG. 4A is a top plan view of an example of two sprites in one embodiment of present invention;

FIG. 4B is a top plan view of an example of one sprite layered on top of another sprite in one embodiment of the present invention;

FIG. 4C is a top plan view of an example of the use of transparent pixels when one sprite is layered on top of another sprite in one embodiment of the present invention;

FIG. 5A is a top plan view of an example of a background sprite in one embodiment of the present invention;

FIG. 5B is a top plan view of an example of a foreground sprite in one embodiment of the present invention;

FIG. 6A is a top plan view of an example of a moving background sprite, a portion of which is displayed on the display frame and a foreground sprite displayed on the display frame in one embodiment of the present invention;

FIG. 6B is a top plan view of an example of a moving background sprite, a different portion of which is displayed on the display frame and a foreground sprite displayed on the display frame in one embodiment of the present invention;

FIG. 6C is a top plan view of an example of a moving background sprite, a different portion of which is displayed on the display frame and a foreground sprite displayed on the display frame in one embodiment of the present invention;

FIG. 7 is a flow diagram of one embodiment of the present invention;

FIG. 8 is a flow diagram of another embodiment of the present invention; and

FIG. 9 is a top plan view of an example of two moving sprites and one static sprite in one embodiment of the present invention.

### DETAILED DESCRIPTION OF THE INVENTION

### I. Gaming Device Structure

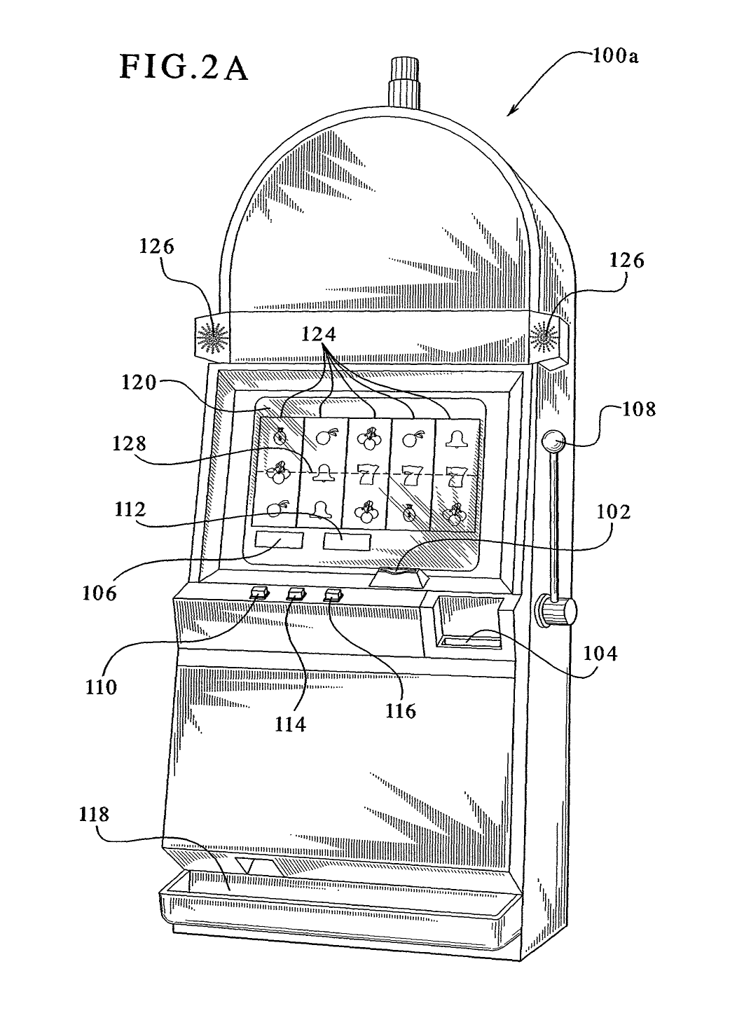

Referring now to FIGS. 2A and 2B, two embodiments of the gaming device of the present invention are illustrated therein as gaming device 100a and gaming device 100b, respectively. Gaming device 100a and/or gaming device 100b are generally referred to herein as gaming device 100. Gaming device 100 is preferably a slot machine having the controls, displays and features of a conventional slot machine. It is constructed so that a player can operate it while standing or sitting, and gaming device 100 is preferably mounted on a console. However, it should be appreciated that gaming device 100 can be constructed as a pub-style table-top game (not shown) which a player can operate preferably while sitting. Furthermore, gaming device 100 can be constructed with varying cabinet and display designs, as illustrated by the designs shown in FIGS. 2A and 2B. Gaming device 100 can also be implemented as a program code stored in a detachable cartridge for operating a hand-held video game device. Also, gaming device 100 can be implemented as a program code stored on a disk or other memory device which a player can use in a desktop or laptop personal computer or other computerized platform.

Gaming device 100 can incorporate any primary game such as slot, poker or keno, any of their bonus triggering events and any of their bonus round games. The symbols and indicia used on and in gaming device 100 may be in mechanical, electrical or video form.

As illustrated in FIGS. 2A and 2B, gaming device 100 includes a coin slot 102 and bill acceptor 104 where the player inserts money, coins or tokens. The player can place coins in the coin slot 102 or paper money or ticket vouchers in the bill acceptor 104. Other devices could be used for accepting payment such as readers or validators for credit cards or debit cards. When a player inserts money in gaming device 100, a number of credits corresponding to the amount deposited is shown in a credit display 106. After depositing the appropriate amount of money, a player can begin the game by pulling arm 108 or pushing play button 110. Play button 110 can be any play activator used by the player which starts any game or sequence of events in the gaming device.

As shown in FIGS. 2A and 2B, gaming device 100 also includes a bet display 112 and a bet one button 114. The player places a bet by pushing the bet one button 114. The player can increase the bet by one credit each time the player pushes the bet one button 114. When the player pushes the bet one button 114, the number of credits shown in the credit display 106 decreases by one, and the number of credits shown in the bet display 112 increases by one.

At any time during the game, a player may “cash out” and thereby receive a number of coins corresponding to the number of remaining credits by pushing a cash out button 116. When the player “cashes out,” the player receives the coins in a coin payout tray 118. The gaming device 100 may employ other payout mechanisms such as credit slips redeemable by a cashier or electronically recordable cards which keep track of the player's credits.

Gaming device 100 also includes one or more display devices. The embodiment shown in FIG. 2A includes a central display device 120, and the alternative embodiment shown in FIG. 2B includes a central display device 120 as well as an upper display device 122. Gaming device 100 preferably displays a plurality of reels 124, preferably three to five reels 124 in mechanical or video form at one or more of the display devices. However, it should be appreciated that the display devices can display any visual representation, animation or exhibition, including but not limited to movement of physical objects such as mechanical reels and wheels, dynamic lighting and video images.

A display device can be any viewing surface such as glass, a video or computer monitor or screen, a liquid crystal display or any other display mechanism. If the reels 124 are in video or computer graphic form, the display device for the reels 124 is preferably a video or computer monitor. In certain instances it is preferable to use a touch screen and associated controller (not shown) instead of a conventional video monitor display device. A player can make decisions and input signals into the gaming device 100 by touching the touch screen at the appropriate places.

Each reel 124 displays a plurality of indicia such as bells, hearts, fruits, numbers, letters, bars or other images which preferably correspond to a theme associated with the gaming device 100. Furthermore, gaming device 100 preferably includes speakers 126 for making sounds or playing music.

With reference to FIGS. 2A and 2B, to operate the gaming device 100 in one embodiment the player must insert the appropriate amount of money or tokens at coin slot 102 or bill acceptor 104 and then pull the arm 108 or push the play button 110. The reels 124 will then begin to spin. Eventually, the reels 124 will come to a stop. As long as the player has credits remaining, the player can spin the reels 124 again. Depending upon where the reels 124 stop, the player may or may not win additional credits.

In addition to winning credits in this manner, preferably gaming device 100 also gives players the opportunity to win credits in a bonus round. This type of gaming device 100 will include a program which will automatically begin a bonus round when the player has achieved a qualifying condition in the game. This qualifying condition can be a particular arrangement of indicia on a display device. The gaming device 100 preferably uses a video-based central display device 120 or upper display device 122 to enable the player to play the bonus round. Preferably, the qualifying condition is a predetermined combination of indicia appearing on a plurality of reels 124. As illustrated in the five reel slot game shown in FIGS. 2A and 2B, the qualifying condition could be the number seven appearing on three adjacent reels 124 along a payline 128. It should be appreciated that the present invention can include one or more paylines, such as payline 128, wherein the paylines can be horizontal, diagonal or any combination thereof.

### II. Computer System

### A. Computer System Hardware

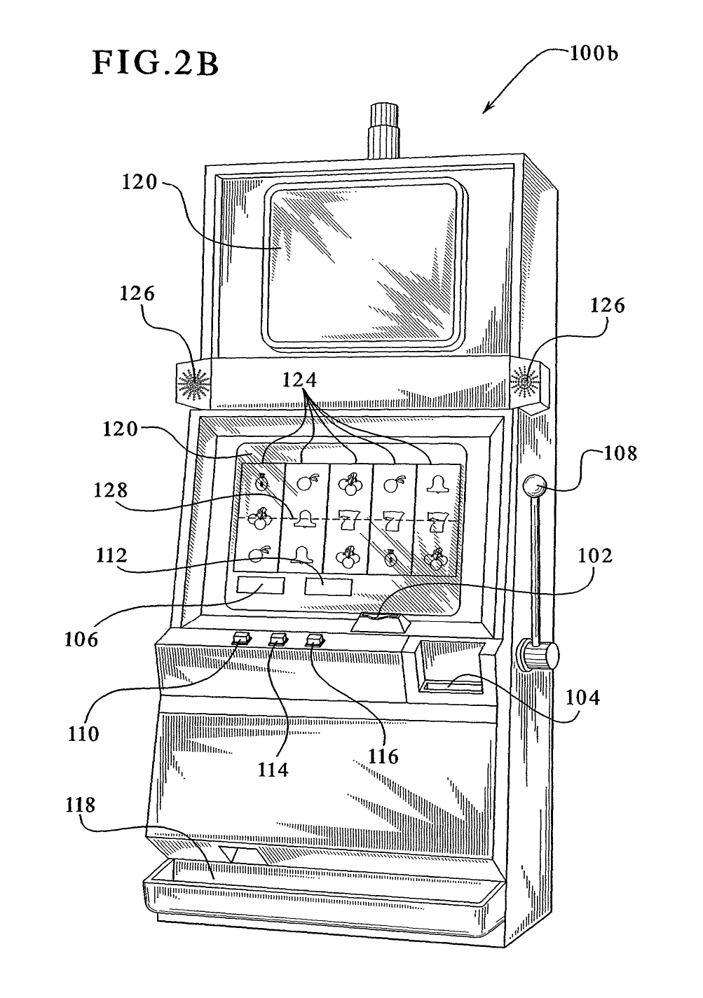

The gaming device of the present invention includes a computer system which displays one or more sprites or portions of one or more sprites in one or more frames on a display frame of a display device. As schematically shown in FIG. 3, one embodiment of the present invention includes a computer system 200, generally identified in FIG. 3. Computer system 200 includes: a central processing unit (CPU) 202; a memory device 204 for storing program code or other data; a sprite random access memory (RAM) 206; a display processor 208; one or more display devices (such as a central display device 120 and/or upper display device 122); a display frame 210 associated with each display device; a sound card 212; a plurality of speakers 126; and one or more input devices 214. A bus 216 electrically connects all of these components and enables them to communicate with one another.

The CPU 202 is preferably a microprocessor or microcontroller-based platform which is capable of displaying images, animations, symbols and other indicia such as images of people, characters, objects, places, things and faces of cards. The memory device 204 can include a random access memory (RAM) 218 for storing event data or other data generated or used during a particular game. The memory device 204 can also include read only memory (ROM) 220 for storing animation program code or other program code which controls the gaming device 100 so that it plays a particular game in accordance with applicable game rules and pay tables. Also, sprite RAM 206 includes a plurality of individual sprite buffer random access memory devices 222 (referred to herein as “sprite buffers 222”).

Preferably, ROM 220 stores a sprite program code which CPU 202 uses to write pixel data for various sprites. This sprite code can be written in various computer languages, including, without limitation, Java, C++, other equivalent languages and any other languages existing presently or in the future which enable the CPU to write pixel data for sprites.

In this embodiment, preferably the display device is either constructed of cathode ray tubes (CRT) or flat-panel displays. This type of display device utilizes raster graphics in which an image is specified in terms of an array of component pixels. Accordingly, display frame 210 is formed from a set of horizontal scan lines, each made up of individual pixels (not shown). Consequently, the display frame 210 is a matrix of pixels covering the entire screen area of the display device. The display frame 210 can be of any size, height, width or other dimension, depending upon the size and shape of the display device. Preferably, the display frame 210 is approximately square, having coordinates based upon the number of pixels. For example, a display frame 210 could have lower left coordinates of (0, 0) and upper right coordinates of (500, 500). It should be appreciated that display frame coordinates or any other coordinates can extend outside of the display frame 210. In this example, locations outside of the display frame 210 could have, for instance, a graphical image could have lower left coordinates of (−4000, −100) and upper right coordinates of (1000, 200). A game developer specifies a display frame 210 with a matrix of pixel values which correspond to the pixel matrix. These values specify color and brightness.

As is typical in computer systems of this nature, computer system 200 preferably runs under a supervisory operating system. The operating system provides functions or device drivers for performing specific hardware-related and input/output operations. Application programs are desirably written to use these built-in functions. Alternatively, hardware operations can be performed by application programs themselves.

It should be appreciated that although a CPU 202 and memory device 204 are preferable implementations of the present invention, the present invention can also be implemented using one or more application-specific integrated circuits (ASIC's) or other hard-wired devices, or using mechanical devices (collectively referred to herein as a “CPU”). Furthermore, although the CPU 202 and memory device 204 preferably reside on each gaming device 100 unit, it is possible to provide some or all of their functions at a central location such as a network server for communication to a playing station such as over a local area network (LAN), wide area network (WAN), Internet connection, microwave link, and the like.

As illustrated in FIG. 3, to operate the gaming device, the player preferably uses the input devices 214, such as pull arm 108, play button 110, the bet one button 114 and the cash out button 116 to input signals into gaming device 100. As further illustrated in FIG. 3, the CPU 202 can be connected to coin slot 102 or bill acceptor 104. CPU 202 can be programmed to require a player to deposit a certain amount of money in order to start the game.

### B. Sprites

In the embodiment illustrated in FIG. 3, the computer system 200 is capable of generating animations in a single frame. Generally, the computer system 200 accomplishes this by using a sprite program to write data for a plurality of sprites and then separately storing this data and separately displaying the sprites.

The sprite program, preferably stored in ROM 220, can include a plurality of specifications for sprites, including, without limitation: (a) the Z level of the sprite; (b) the horizontal and vertical position (at times referred to herein as the “XY position”) of a sprite on the display frame 210; (c) the velocity of the sprite; (d) the size or dimensions of the sprite; (e) the boundary for the sprite; (f) the array of frames; and (g) the current frame.

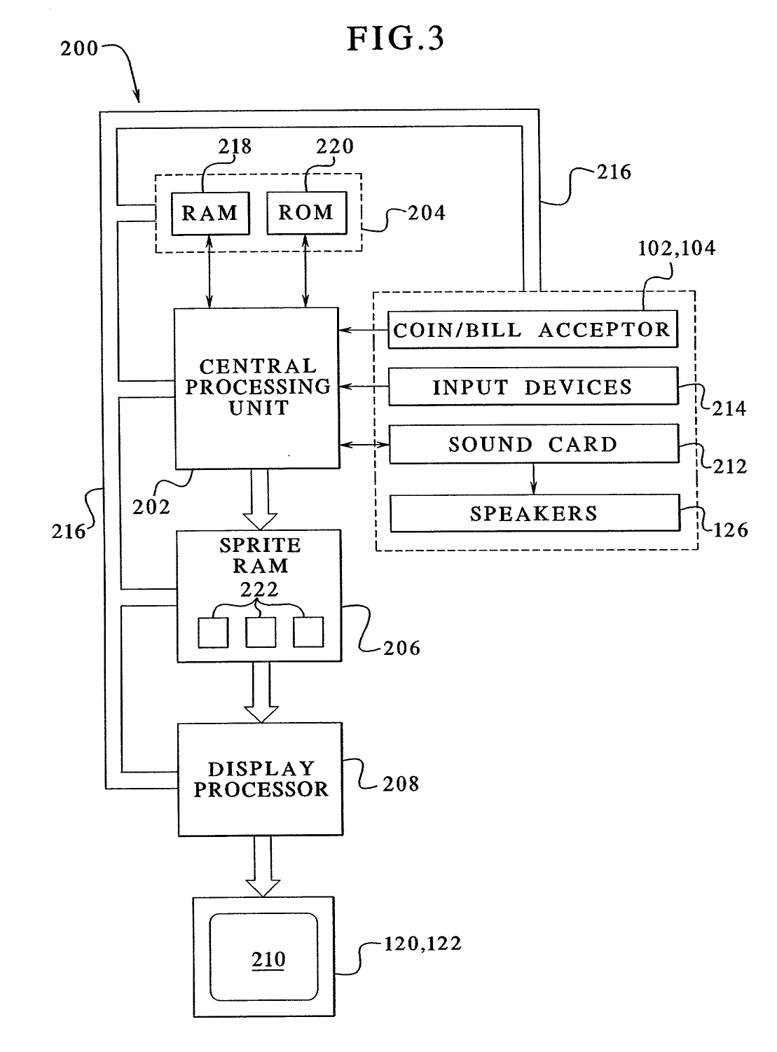

A game developer must specify the Z-level of each sprite. Each sprite is assigned a different Z-level. The Z-level represents the depth of a sprite into the display frame in relation to other sprites. A simple application of the Z-level concept involves a background sprite and a foreground sprite. The background sprite is specified with a higher Z-level or depth than the Z-level specified for the foreground sprite. To illustrate the Z-level concept, FIG. 4A shows two individual sprites: a tree sprite 224 and a car sprite 226. The tree sprite 224, serving as a background sprite, remains stationary in this example, and the car sprite 226, serving as a foreground sprite, is to move across the display frame 210 in front of the tree sprite 224. To accomplish this, the game developer specifies the car sprite 226 with a Z-level of one and specifies the tree sprite 224 with a Z-level of two. The greater the level number, the deeper the sprite is positioned within the display frame 210.

A game developer must also specify the XY position of a sprite. The XY position determines where the sprite is located, preferably according to display frame coordinates, as described below. It should be appreciated that portions of a sprite can be positioned outside of the display frame. A game developer can move a sprite by altering its XY position or by specifying a particular velocity and allowing the sprite to alter its position by itself.

The specified size or dimensions of a sprite can be greater or lesser than the size or dimensions of the display frame and of other sprites. In one preferred embodiment described below, a background sprite is wider than the display frame width. The specified boundary of the sprite determines the region in which the sprite can move. For some sprites (such as characters), the boundary is preferably specified as the size of the display frame. For other sprites (such as moving or scrolling backgrounds), the boundary is preferably specified as much larger than the display frame.

Optionally, the game developer can specify a certain number of frames for a sprite. This concept combines traditional frame-based animation, described earlier, with sprite animation. By doing so, a sprite can exhibit scalar, scrolling or point-to-point movement, in addition to non-scalar movement, such as a character's gestures or body language. In such a case, the game developer must specify the current frame for the sprite.

In addition, the sprite program can include instructions which enable the computer system 200 to detect when a sprite collides with another sprite. This feature is commonly known a collision detection. There are several known techniques for collision detection, any one of which can be implemented in the sprite program of the present invention. A basic technique, known as rectangle collision, involves surrounding each sprite in a rectangle. The CPU 202 compares the relative positions of all of the rectangles and detects when rectangles collide. This method has disadvantages when used with non-rectangular sprites. For this reason, more advanced methods have been developed such as collision detection using shrunken rectangle collision or sprite image data. These methods are well known in the graphics computer programming field and will not be described herein.

FIGS. 4A through 4C illustrate one example of the effects of the sprite specifications discussed above. As discussed earlier, the Z-levels have been properly specified for the tree sprite 224 and car sprite 226 so that the tree sprite 224 appears behind the car image 226. In addition, the XY positions are specified for the two sprites. Preferably, the XY positions are specified in terms of display frame coordinates. With respect to movement, the computer programmer includes an increasing horizontal position for the car sprite 226 or specifies a velocity for the car sprite 226. As to the sprite size specification, in this example, the sprites have been specified with particular sizes or dimensions which are smaller than the display frame size or dimensions. Thus, the sprites fit entirely within the display frame. Also, the boundary is specified as the display frame. As shown in FIG. 4B, these specifications cause the car sprite 226 to appear to be in front of the tree sprite 224. To make the car sprite 226 appear to pass behind the tree sprite 224, the game developer would have to specify a Z-level of one for the tree sprite 224 and a Z-level of two for the car sprite 226.

The animation illustrated in FIG. 4B appears somewhat unrealistic due to the rectangle surrounding the car sprite 226. To improve such an animation, it is preferable that the game developer specifies certain pixels as unused or transparent, referred to herein as “transparent pixels.” Transparent pixels do not cover or obscure underlying pixels of underlying sprites, such as the tree sprite 224. As shown in FIG. 4C, all of the pixels in the rectangle surrounding the car sprite 226 were specified as transparent pixels. As such, the animation appears much more realistic.

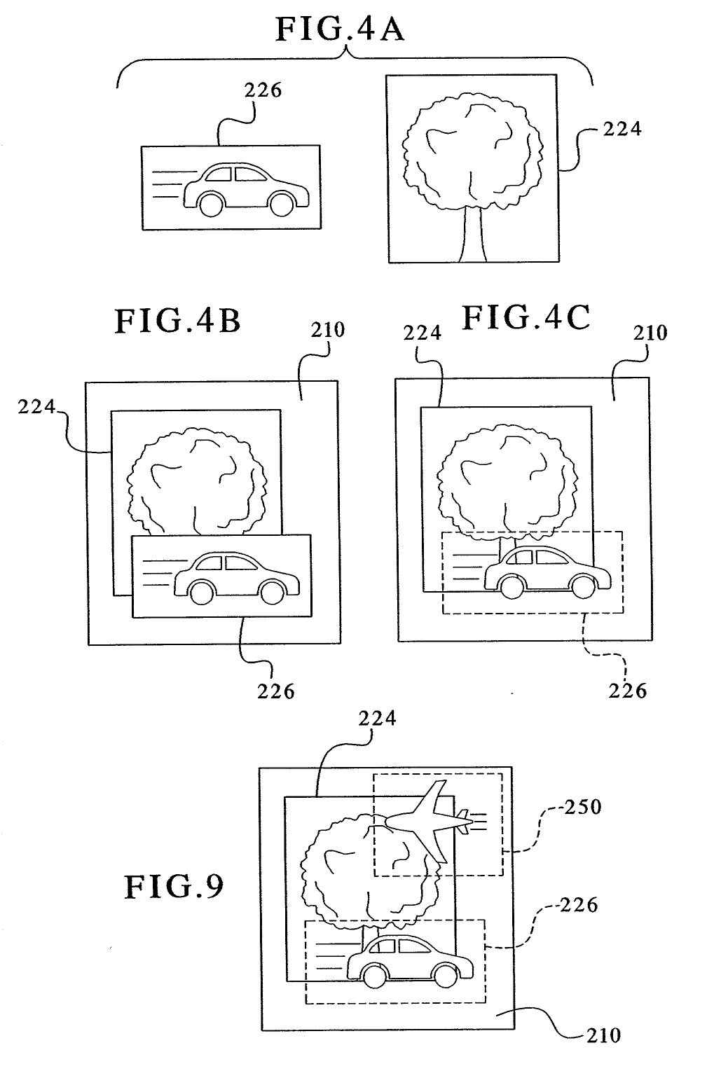

In one preferred embodiment, a background sprite is specified with a size or dimensions greater than that of the display frame. This background sprite is also preferably specified with scrolling or movement, either through a velocity specification or changing XY position specification. In the example illustrated in FIG. 5A, the background sprite 300 includes graphical scenery involving buildings and trees. Preferably, the graphics within the background sprite 300 are not animated. It should be appreciated, however, that the graphics in the background sprite 300 can incorporate frame-based animation in order to create animation within the background sprite 300 itself. As illustrated in FIG. 5B, the foreground sprite 302 is a representation of a character. Preferably, the arms and legs of the character appear to be moving through the use of frame-based animation. The foreground sprite 302 is not, however, specified with a scalar or point-to-point movement.

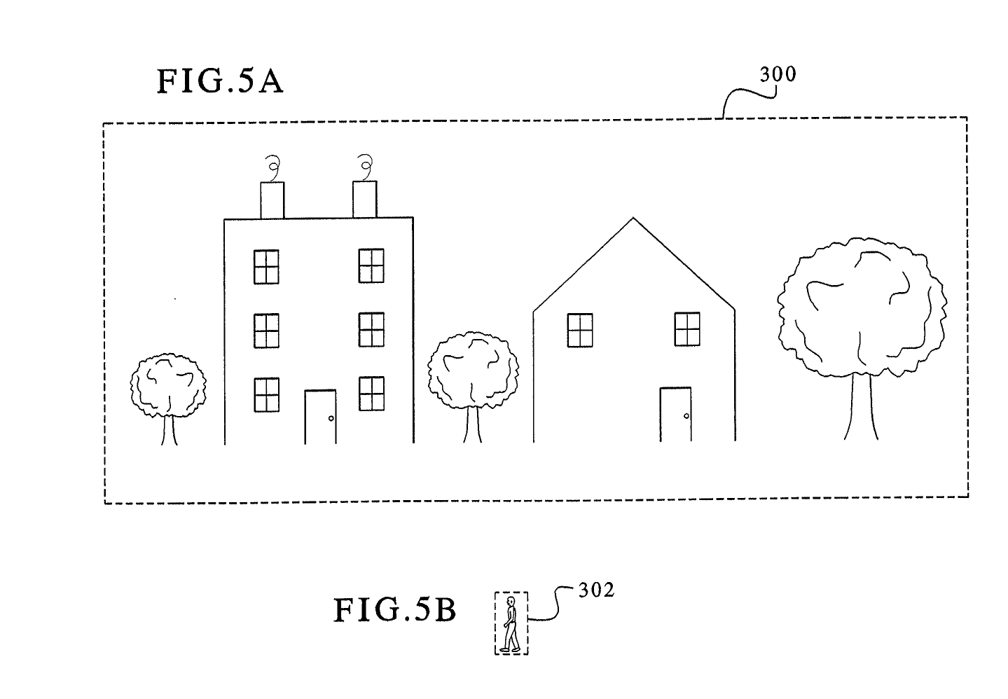

As illustrated in FIGS. 6A through 6C, background sprite 300 is more than three times wider than display frame 210. As indicated by the coordinates on display frame 210 and background sprite 300, display frame 210 is five hundred pixels wide and five hundred pixels high, and background sprite 300 is seventeen hundred pixels wide and six hundred pixels high. (The width dimension, as used here, is a measurement along the x-axis, and the height dimension, as used here, is a measurement along the y-axis.).

The display processor can display sprites which are larger than the display frame or portions of such sprites in any suitable fashion. In one embodiment, the sprite is divided into a plurality of modular compartments or sections. Each section is equal to or smaller than the display frame size or dimensions and is positioned within the display frame. The CPU writes pixel values for each section. Since the sections are all part of a single sprite, they share the same Z-level. To prevent sections from overlapping, interfering or combining, at any one time the CPU writes transparent pixel values for all but one of the sections. Section by section, as time elapses, the CPU writes non-transparent pixel values for a new section and transparent pixel values for the old section. The sections are modular in the sense that one or more of them can be removed from a sprite and/or used to augment a sprite. It should be appreciated that other code-based and/or hardware-based techniques can be employed to accommodate sprites which are larger than display frames.

Referring back to FIG. 6A, foreground sprite 302 is positioned near the lower right portion of display frame 210. In addition, background sprite 300 is specified with a scalar, scrolling or point-to-point movement from left to right. Preferably, this movement is accomplished by specifying a velocity for background sprite 300; however, it can be accomplished by specifying changing XY positions. In any case, background sprite 300 scrolls or moves from left to right.

As illustrated in FIGS. 6B and 6C, as background sprite 300 scales or moves to the right, foreground sprite 302 does not scale. However, the moving background sprite 300 causes the foreground sprite 302 to appear to be moving or scaling to the left. The animation is made more realistic with the non-scalar movement of the arms and legs of the character in the foreground sprite 302. In this example of this embodiment, the character appears to have walked from the right side of the large tree to the left side of the house.

In this embodiment, the entire scenery or background of a game can change with the use of a single, moving or scrolling background sprite which is larger than the display frame. In a specific application, nonmoving foreground sprites can have apparent scalar or point-to-point movement through the use of this type of background sprite. Moreover, since the background image is based upon sprite animation instead of frame animation, valuable processing and memory resources are saved. The saved resources can be devoted to increased processing speed for more realistic and engaging gaming device animation.

Although the sprite in this example of this embodiment which is larger than the display frame is referred to as a background sprite, it should be appreciated that this embodiment can include any type of sprite which is larger than the display frame.

In a particular embodiment, the computer system of the present invention generates a non-moving sprite which is the scope site of a gun on a vehicle. The scope site sprite, comprised of a plurality of highlighted lines, is displayed against a scrolling or moving background sprite. The background sprite includes a solid black background and planet structures and is larger than the display frame. The XY position of the background sprite scrolls or moves on a Z-level behind the static scope site sprite. This movement makes the scope site appear to be moving.

### C. Operation of Computer System

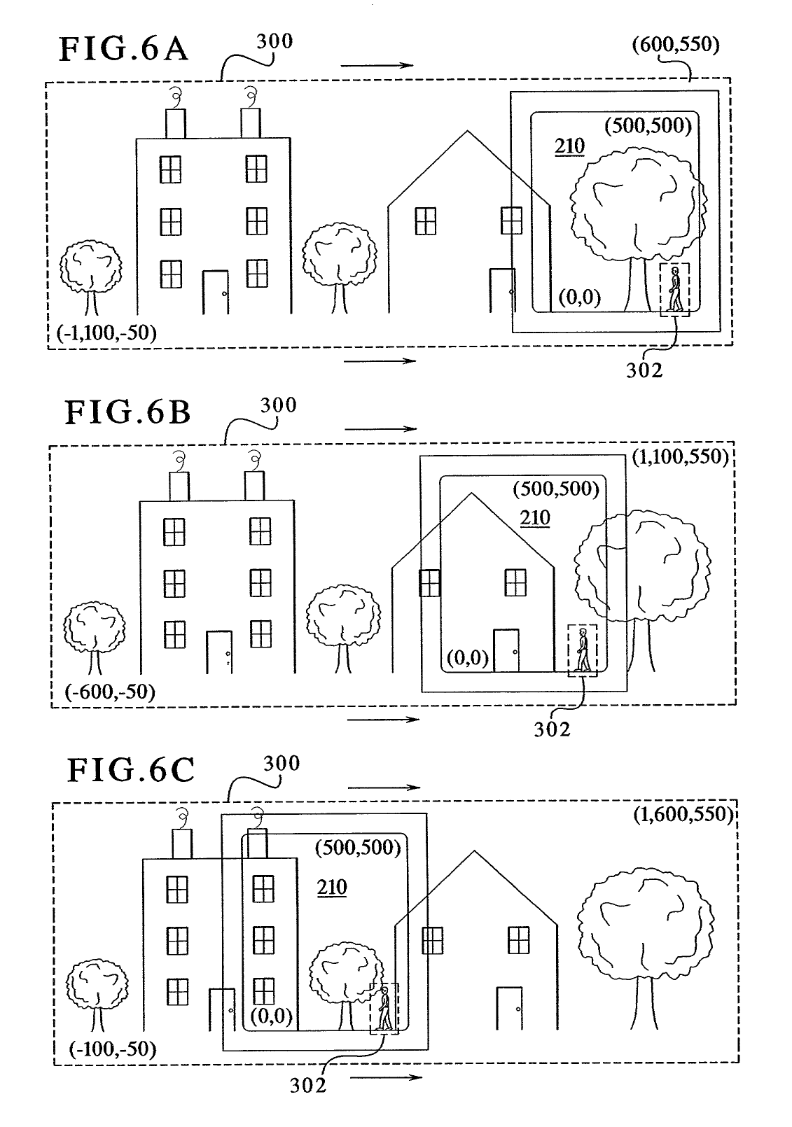

FIG. 7 shows the steps of operation for the embodiment of computer system 200 as illustrated in FIG. 3. As instructed by the sprite program stored in the memory device 204, CPU 202 will write pixel data or values for a predetermined number of sprites. CPU 202 writes these pixel values to sprite buffers 222 for each sprite as indicated by block 228. When CPU 202 completes this task, each sprite will have an associated sprite buffer 222 which stores the pixel values for that sprite. If a pixel is specified as a transparent pixel, the CPU 202 will not transfer the pixel values from the sprite buffers 222, as indicated by diamond 230 and block 232. If the pixels are not transparent, the CPU 202 transfers the pixel values from each sprite buffer 222 to the display processor 208, as indicated by block 234. Next, the display processor 208 drives the display device to display the separate sprites on display frame 210, as indicated by block 236. This completes the sprite animation for a game.

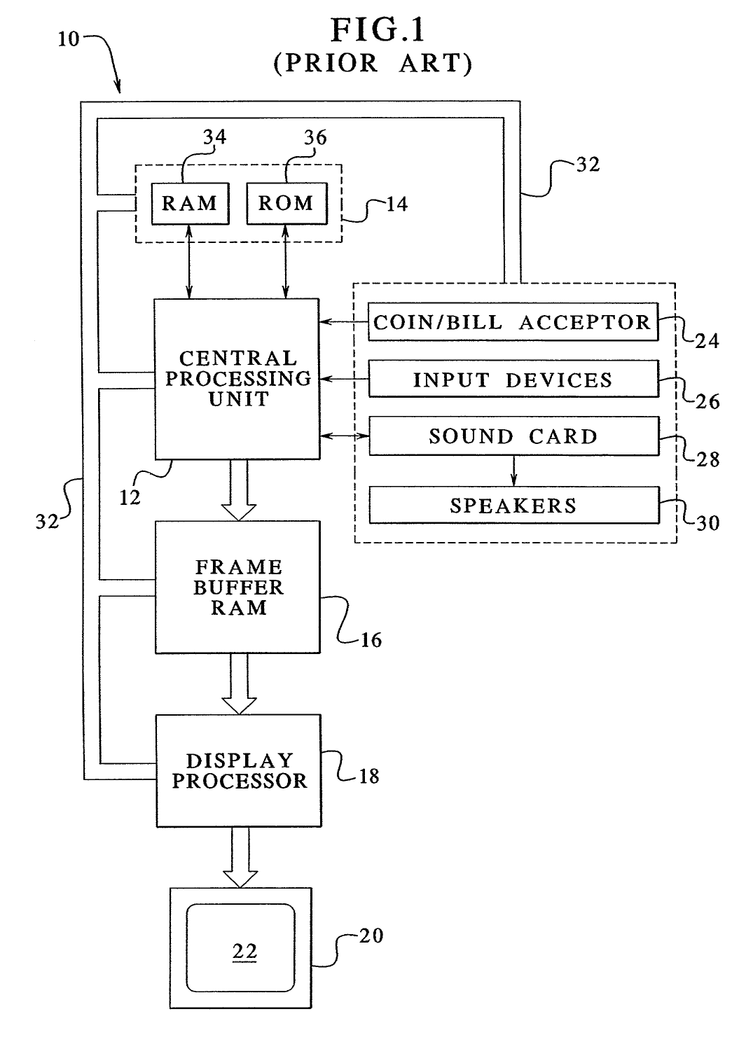

In an alternative embodiment, the computer system can comprise the traditional computer system 10 as illustrated in FIG. 1. This embodiment requires a relatively high amount of steps when compared to the previously discussed embodiment. However, if necessary, the traditional computer system 10 can be used to generate sprites. The basic concept is that CPU 12 writes pixel values for one graphical image and this graphical image is displayed before CPU 12 writes pixel values for another sprite. The animation program used by CPU 12 must include the appropriate instructions so that framer buffer 16 displays the sprites in a particular order (from most depth to least depth). This type of program enables the traditional computer system 12 to generate sprites with a layered effect without using Z-levels.

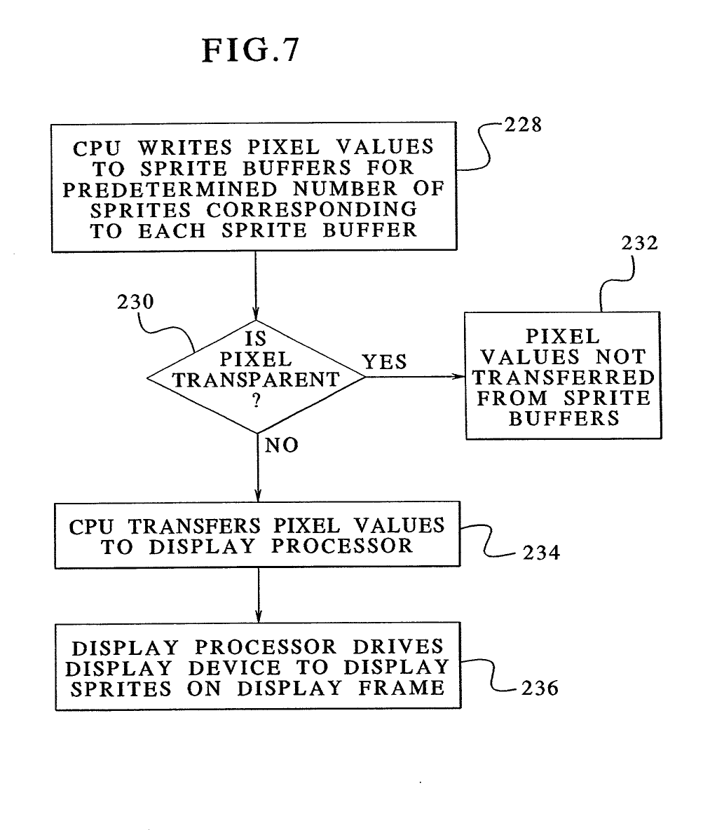

With reference to FIGS. 1 and 8, the animation program stored in memory device 14 instructs CPU 12 to write pixel values for a predetermined number of sprites. As discussed earlier, the game developer predetermines the desired depths of each sprite. In this embodiment, CPU 12 must write pixel values to frame buffer 16 for each sprite separately. Furthermore as indicated by block 236 in FIG. 7, CPU 12 writes pixel values for the sprites in the order of decreasing depth. In the car and tree example shown in FIG. 4A, CPU 12 would write pixel values for the tree sprite 224 before writing pixel values for the car sprite 226.

Again, if any pixel is transparent, CPU 12 will not transfer the corresponding pixel values from the frame buffer 16, as indicated by diamond 238 and block 240. If the pixel is not transparent, the CPU 12 transfers the pixel values for a single sprite to display processor 18, as indicated by block 242. As indicated by block 244, display processor 18 then drives display device 20 to display the sprite on display frame 22. Since this sprite is always the deepest sprite not yet displayed, the pixels of that sprite cover the pixels of any deeper images. As indicated by diamond 246 and block 236, this process repeats itself until all of the sprites are displayed, one by one. The result, as indicated by block 248, is that these sprites appear layered like the sprites which computer system 200 generates with varying Z-levels.

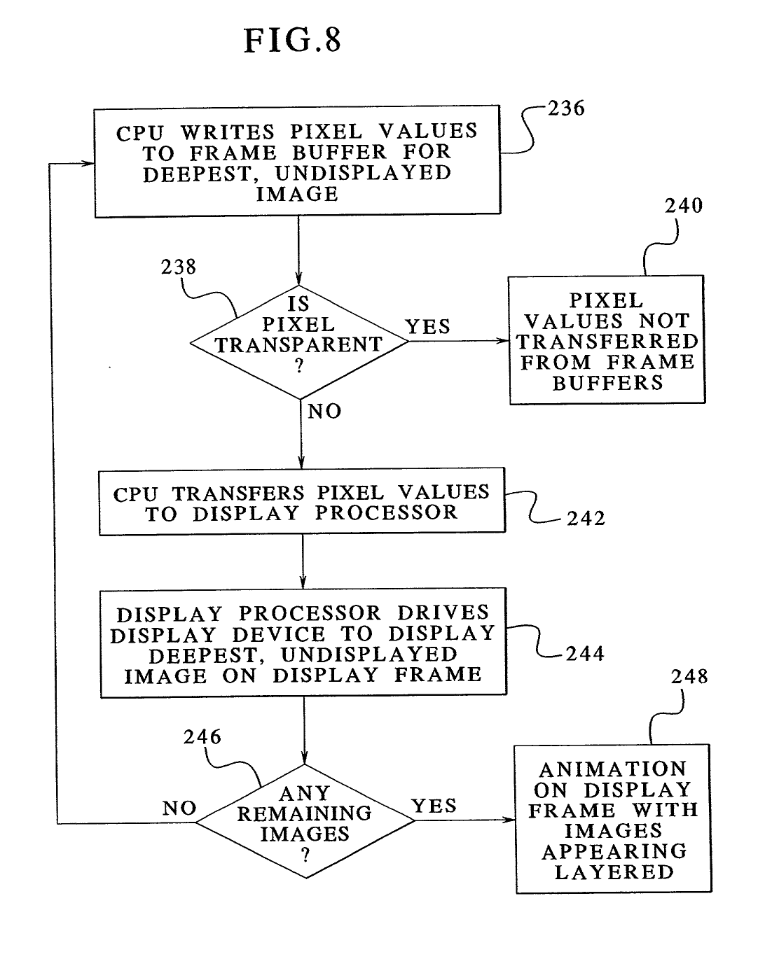

It should be appreciated that in either embodiment of the present invention, the computer system can generate two or more moving or nonmoving sprites. An example of two moving sprites and one static sprite is shown in FIG. 9. This example includes the tree sprite 224, car sprite 226 and an airplane sprite 250. In this example, airplane sprite 250 is assigned a Z-level of one, car sprite 226 is assigned a Z-level of two and tree sprite 226 is assigned a Z-level of three. In addition, car sprite 226 and airplane sprite 250 are each specified with velocities and are moving in opposite directions at different rates.

Other embodiments of the computer system of the present invention are specific to the field of gaming devices. As described earlier, a gaming device includes conventional slot games with physical reels, contemporary slot games with video reels, video card games and other wagering games. Any of these games can include a primary game and one or more bonus rounds. Generally, these games involve providing a player with the opportunity to reach one or more predetermined symbols or combinations of symbols. In primary games, the symbols are displayed on virtual rotating reels, wheels and/or cards. The symbols themselves vary with the particular game theme and include graphics of characters, scenery and various things such as vehicles.

The computer system of the present invention includes various embodiments involving gaming device animations. The primary game of one such embodiment includes a plurality of rotating, virtual or video reels which are created by the computer system as separate sprites. In another primary game embodiment, each reel displays a plurality of symbols, and these symbols travel from one reel to another. The computer system creates and animates these traveling symbols as sprites. In yet another primary game, which includes one or more rotating, virtual wheels, the computer system creates the wheels as sprites and animates them accordingly. In a card-based embodiment, the primary game includes a plurality of cards. The computer system of the present invention animates the cards by creating them as separate sprites.

Turning to bonus rounds, one embodiment includes a plurality of selections displayed against background scenery. The player must choose one or more selections. At some time during the bonus round, one or more of the selections exhibit movement. The computer system animates the selections by creating them as separate sprites. The computer system also creates the background scenery as a separate sprite, preferably with no movement. In an alternative embodiment, a bonus round includes a character or thing chasing after or racing against another character or thing. This bonus round also includes one or more relatively large graphical backgrounds. The computer system creates the characters, backgrounds and things as separate sprites and animates their scalar movement accordingly. In yet another embodiment, a character carries out some action, such as running, jumping or throwing. The character image is displayed against a background image. Again, the computer system generates the animation by creating the character image and background image as separate sprites.

The computer system of the present invention provides gaming devices with the capacity to display multiple graphical images or sprites simultaneously in computer game animations. Preferably, the computer system includes sprite-configured software which can accommodate Z-level specifications for sprites, in addition to a plurality of other specifications. Other specifications include, without limitation, velocity and size or dimensions (such as a sprite having a size or dimensions larger than, smaller than or equal to that of the display frame). This type of computer system conserves computer system resources and allows for such resources to be intelligently allocated to predetermined graphical images. The result is enhanced, more realistic and more interactive graphics, increasing the enjoyment and entertainment experienced by gaming device players.

While the present invention has been described in connection with what is presently considered to be the most practical and preferred embodiments, it is to be understood that the invention is not limited to the disclosed embodiments, but on the contrary is intended to cover various modifications and equivalent arrangements included within the spirit and scope of the claims. It is thus to be understood that modifications and variations in the present invention may be made without departing from the novel aspects of this invention as defined in the claims, and that this application is to be limited only by the scope of the claims.

The invention is hereby claimed as follows:

1. A gaming device comprising:
at least one display device;
at least one memory device;
a processor adapted to retrieve from the memory device data which represents a plurality of graphical images and to generate the graphical images on the display device; and
a display frame defined by the display device, said display frame having predetermined dimensions,
whereby at least one of the graphical images specified by the data has at least one dimension which is larger than one dimension of the display frame.

2. The gaming device of claim 1, wherein the memory device includes a plurality of image buffers.

3. The gaming device of claim 1, which includes varying screen depths associated with each graphical image.

4. The gaming device of claim 1, which includes varying Z-level positions associated with each graphical image.

5. The gaming device of claim 1, which includes an XY position associated with each graphical image.

6. The gaming device of claim 5, wherein at least one of the XY position is adapted to change with time.

7. The gaming device of claim 1, which includes a velocity associated with at least one graphical image.

8. The gaming device of claim 1, which includes at least one animation defined by the plurality of graphical images.

9. The gaming device of claim 1, wherein the data includes pixel values.

10. The gaming device of claim 9, which includes transparent pixel values.

11. The gaming device of claim 1, which includes means for detecting collisions of graphical images.

12. The gaming device of claim 1, whereby the display device is adapted to display at any one time a portion of at least one of the graphical images, wherein said graphical image is larger than the display frame.

13. The gaming device of claim 12, wherein the larger graphical image is a background image.

14. The gaming device of claim 12, which includes a velocity specified for the larger graphical image.

15. The gaming device of claim 12, which includes a changing position specified for the larger graphical image.

16. The gaming device of claim 1, wherein said dimensioned graphical image includes a plurality of sections.

17. The gaming device of claim 16, wherein said sections are modular.

18. An improved gaming device including a processing unit adapted to communicate with a memory device, at least one buffer memory device, a display processor and at least one display device which includes a display frame wherein the display frame is adapted to display, at any one time, at least one graphical image, wherein the improvement comprises: said graphical image being specified to have at least one dimension which is larger than at least one display frame dimension.

19. The improved gaming device of claim 18, wherein said specified graphical image includes a plurality of sections.

20. An improved gaming device including a processing unit adapted to communicate with at least one memory device and at least one display device including a display frame, said the processing unit adapted to generate at least one animation by displaying a plurality of graphical images simultaneously, wherein the improvement comprises: at least one of the graphical images having a size which requires that only part of the graphical image be displayed on the display frame at any one time.

21. The improved gaming device of claim 20, wherein said sized graphical image includes a plurality of sections.

22. A method of enabling a player to view a gaming device animation, said method comprising the steps of:
(a) retrieving from a memory device, data representing a plurality of graphical images, said data specifying at least one of the graphical images to have at least one dimension which is larger than at least one display frame dimension;
(b) transferring said data to image buffers, each of which is associated with a graphical image; and
(c) displaying at least part of certain graphical images on a display frame.

23. The method of claim 22, which includes the step of displaying a plurality of graphical images simultaneously.

24. The method of claim 22, which includes the step of displaying the graphical images at different screen depths.

25. The method of claim 22, which includes the step of moving at least one graphical image.

26. The method of claim 22, which includes the step of retrieving data from a memory device representing graphical images of various sizes.

27. The method of claim 22, which includes the step of retrieving data representing at least one background graphical image having a size larger than a display frame dimension.

28. The method of claim 22, which includes the step of retrieving data representing at least one background graphical image having a size larger than all other graphical images.

29. The method of claim 27, which includes the step of specifying a velocity for the background graphical image.

30. The method of claim 27, which includes the step of specifying a changing XY position for the background graphical image.

31. The method of claim 27, which includes the step of causing the background graphical image to appear to be moving.

32. The method of claim 27, which includes the step of moving the background graphical image.

33. The method of claim 27, which includes the step of maintaining the background graphical image in a static condition.

34. The method of claim 33, which includes the step of moving at least one graphical image, other than the background graphical image.

35. The method of claim 22, which includes the step of creating an animation.

36. The method of claim 22, which includes the step of creating an animation by moving at least one graphical image.

37. The method of claim 22, which includes the step of conserving computer memory by creating an animation by moving one graphical image instead of generating a plurality of frames of graphical images in succession.

38. The method of claim 22, which includes the steps of transferring pixel values to the image buffers and transferring pixel values to the display processor.

39. The method of claim 22, which includes the step of maintaining transparent pixel values in the image buffers.

40. The method of claim 22, which includes the step of providing a screen connected to said display processor.

41. The method of claim 40, which includes the step of causing said screen to appear to move.

42. The method of claim 22, which includes the step of enabling a player to determine the direction in which said graphical image moves.

43. The method of claim 22, which includes the step of enabling a player to evaluate the velocity at which said graphical image moves.

44. The method of claim 22, wherein step (c) includes the step of displaying at least one section of at least one graphical image, wherein said graphical image is larger than a display frame dimension.

45. The method of claim 22, wherein step (c) includes the step of displaying at least one section of at least one graphical image.

46. The method of claim 45, which includes the step of retrieving transparent data which represents certain sections of certain graphical images.

47. The method of claim 46, which includes the step of transferring said transparent data to certain image buffers.

48. A method of enabling a player to view at least one animation on a gaming device, said method comprising the steps of:
(a) retrieving from a memory device, varying depth orders associated with a plurality of graphical images;
(b) retrieving from a memory device, a plurality of pixel values representing the graphical images, at least one of said graphical images having a dimension which is greater than at least one display frame dimension;
(c) transferring the values to at least one frame buffer;
(d) transferring the values associated with each graphical image to at least one display processor, in order of decreasing depth; and
(e) displaying the graphical images, image-by-image.

49. The method of claim 48, wherein step (d) causes the pixel value transferred to a particular frame buffer location to replace any pixel value previously transferred thereto.

50. The method of claim 48, which includes the step of displaying a plurality of graphical images in succession.

51. The method of claim 48, which includes the step of animating at least one graphical image by displaying a plurality of graphical images in succession which consist of variations of such graphical image.

52. The method of claim 48, which includes the step of causing such graphical images to appear to be layered on a display device.

53. A gaming device comprising:
at least one display device including a display frame having predetermined dimensions;
at least one memory device including pixel data associated with at least one graphical image which is larger in size than the at least one display frame dimension; and
processor means for accessing said memory device to obtain said pixel data, processing said pixel data and sending signals to said display device based on said processed pixel data.

54. The gaming device of claim 53, wherein the graphical image has at least one width dimension which is greater than at least one width dimension of the display frame.

55. The gaming device of claim 53, wherein the graphical image has at least one height dimension which is greater than at least one height dimension of the display frame.

56. The gaming device of claim 53, which includes a movement specification associated with the graphical image.

57. The gaming device of claim 53, which includes a scrolling specification associated with the graphical image.

58. The gaming device of claim 53, which includes a velocity specification associated with the graphical image.

59. The gaming device of claim 53, which includes a changing XY position associated with the graphical image.

60. The gaming device of claim 53, which includes a Z-level specification associated with the graphical image.

61. The gaming device of claim 53, which includes a boundary specification associated with the graphical image.

62. The gaming device of claim 61, wherein the boundary specification specifies a boundary larger than at least one of the display frame dimensions.

63. The gaming device of claim 53, wherein only a portion of the graphical image is visible on the display frame at any one time.

64. The gaming device of claim 53, wherein the memory device includes pixel data representing a plurality of graphical images.

65. The gaming device of claim 53, wherein at least one of the graphical images is associated with a scalar movement specification and at least one of the graphical images is associated with a non-scalar movement specification.

66. A method of enabling a player to view at least one animation on a gaming device, said method comprising the steps of:
(a) retrieving from a memory device dimensional data for a graphical image, said data specifying the graphical image to have a dimension which is larger than at least one display frame dimension;
(b) retrieving from a memory device movement data associated with the graphical image;
(c) enabling a processor to write pixel data associated with the graphical image; and
(d) displaying various portions of the graphical image as time elapses.

67. The method of claim 66, which includes the step of retrieving from a memory device Z-level data associated with the graphical image.

68. The method of claim 66, wherein step (a) includes the step of retrieving width data.

69. The method of claim 66, wherein step (a) includes the step of retrieving height data.

70. The method of claim 66, wherein step (b) includes the step of retrieving scrolling movement data.

71. The method of claim 66, wherein step (b) includes the step of retrieving velocity movement data.

72. The method of claim 66, wherein step (b) includes the step of retrieving XY position movement data.

73. The method of claim 66, which includes the step of retrieving pixel data representing a plurality of graphical images.

74. The method of claim 73, which includes the steps of retrieving different Z-level data for at least two graphical images and displaying at least part of each said graphical image simultaneously.
